(19) United States
(12) Patent Application Publication
(10) Pub. No.: US 2011/0064238 A1
(43) Pub. Date: Mar. 17, 2011

(54) MICROPHONE/SPEAKER DEVICE

(75) Inventor: Christian Haas, Gross St. Florian (AT)

(73) Assignee: NXP B.V., Eindhoven (NL)

(21) Appl. No.: 12/842,280

(22) Filed: Jul. 23, 2010

(30) Foreign Application Priority Data
Jul. 24, 2009 (EP) 09166353.4

(51) Int. Cl. G10K 11/16

(52) U.S. Cl. 381/71.6

(57) ABSTRACT

Embodiments provide a microphone/speaker assembly such as a headphone or headset which comprises a mechanical acoustical low pass filter between the microphone and the speaker so as to effectively attenuate higher frequencies fed back to the microphone. The low pass filter may comprise a hole or tunnel which connects a front volume of the microphone with a front volume of the speaker, providing a reliable and effective stable structure. An attenuation material may be provided for adjusting the attenuation of the low pass filter. Other embodiments provide side-by-side microphone and speaker so that the microphone does not distort the speaker acoustic path.

### FIELD OF THE INVENTION

The present invention generally relates to microphone/speaker devices such as headphones.

### BACKGROUND OF THE INVENTION

US 2005/0213773 A1 discloses a noise cancellation system which includes a headphone having a microphone and a headphone speaker. An electric high-pass filter is provided between the output of the microphone of the headphone and the remote noise cancellation circuitry which supplies the headphone speaker.

Generally, feedback noise reduction systems have to deal with the problem of acoustic feedback between speaker and microphone in case these components are located close to each other inside the headphone.

Typically, the microphone used by the noise cancellation system is located between the speaker and the physical output of the system, for example the ear bud opening in the case of an in-ear-canal noise cancellation system. This provides the minimum delay coupling between the speaker and microphone.

### SUMMARY OF THE INVENTION

It is an object of the present invention to provide a microphone/speaker assembly with improved functionality.

Embodiments in accordance with a first aspect of the invention provide an improvement of stability in microphones or headphones, for example regarding acoustic noise reduction headphones such as in-ear-canal feedback acoustic noise reduction headphones.

In accordance with one or more of the embodiments, unwanted acoustic feedback effects between speaker and microphone inside a headphone such as an in-ear-canal feedback acoustic noise reduction (ANR) headphone are reduced.

In accordance with one or more of the embodiments a microphone device such as a headphone or headset is provided with a low-pass filter, optionally a mechano-acoustical low pass filter.

Embodiments in accordance with a second aspect of the invention provide an improvement of the audio playback performance in noise cancellation speakers, for example acoustic noise reduction headphones such as in-ear-canal feedback acoustic noise reduction headphones.

According to a first aspect of the invention, a microphone/speaker assembly is provided which comprises a microphone and a speaker. A mechanical acoustical low pass filter is provided between the microphone and the speaker.

This mechanical filter structure is robust and reliable as well as long-time stable, and does not require electric power supply.

The low pass filter may comprise a hole or tunnel which connects a front volume of the microphone with a front volume of the speaker, providing good efficiency and ease of manufacture.

In accordance with one or more of the embodiments the hole or tunnel may have a round or circular cross-section or a polyangular or rectangular shape, and an optional diameter, or width and thickness, of 0.2 to 2.0 mm; or 0.3 to 1.0 mm; or 0.5 mm. Further, the hole or tunnel may e.g. have a length 1 to 5 mm; or 1.5 to 3 mm; or 2 mm. The low pass filter thus can be structured with compact dimensions.

In accordance with one or more embodiments, the microphone/speaker assembly may comprise a separation wall between a front volume of the microphone and a front volume of the speaker. This separation wall may act as a high pass filter between the front volume of the microphone and a front volume of the speaker.

The hole or tunnel may be arranged between the separation wall and an internal wall of a housing of the microphone assembly, providing a compact and effective structure.

In accordance with one or more embodiments, the separation wall comprises an angular part extending parallel to an internal wall of the housing of the microphone assembly. Therefore, the dimensions of the tunnel (length, cross-section, width, etc) can be easily set to appropriate values so as to achieve a desired low pass filtering characteristic.

Optionally, a damping material for adjusting the attenuation of the low pass filter. The attenuation material may for example be an acoustic fabric or mesh arranged at or in a hole or tunnel of the low pass filter. Optionally, the mesh may be attached to the separation wall and the housing, providing a stable mechanical solution.

Alternatively, or in addition, the attenuation material may be an acoustic foam which may optionally be arranged at or in a microphone front volume or at another appropriate position at or near the hole or tunnel. The foam can easily be inserted into the designated space.

Optionally, the upper corner frequency of the low pass filter is set in the range of 1 to 20 kHz, or 2 to 10 kHz, or 4 to 8 kHz, or about, below or exactly 4 kHz.

The microphone assembly may comprise a tube adapted for insertion into a human ear.

In accordance with one or more embodiments, the microphone/speaker assembly may be at least one of a headphone, a headphone with feedback noise reduction or cancellation, an in-ear-canal headphone, and a headset.

In accordance with one or more of the embodiments a mechanical solution is provided which is e.g. applicable to a microphone/speaker application which reduces the sensitivity of the microphone in the frequency range where instability of the electronic ANR path might occur due to acoustic feedback.

In accordance with one or more of the embodiments of the invention a feedback noise reduction system is provided which effectively deals with the problem of acoustic feedback between speaker and microphone which are located close to each other inside the headphone.

An acoustic feedback may occur especially at frequencies where the electric and/or acoustic phase of the speaker and/or microphone shows a high degree of phase shift. Those frequencies or frequency areas are located at mid to high frequencies where no acoustic noise reduction is needed due to a very high passive acoustic noise insulation of typical in-ear-canal headphone designs.

Therefore, in accordance with one or more of the embodiments, the active part of the noise reduction system optionally works only for the frequency range below 4 kHz. In accordance with one or more of the embodiments a reduction of the microphone sensitivity at the frequency range above that frequency is effective in reducing the instability of typical feedback noise reduction systems caused by acoustic feedback.

In accordance with one or more of the embodiments a sensitivity of the feedback ANR microphone is reduced at mid and high frequencies by a mechanical low pass filter.

According to a second aspect of the invention, a microphone/speaker assembly comprises a microphone and a speaker, with the microphone and speaker arranged side-by-side in a plane perpendicular to the direction of sound projection to the user.

This arrangement means that the microphone does not negatively influence the acoustic path between the speaker and the user.

In one arrangement, the microphone/speaker assembly comprises a housing which defines:

a tube extending in the said direction;

a volume coupled to the internal volume of the tube, the volume being substantially planar in the plane perpendicular to the said direction;

a first coupling between the volume and the speaker; and

a second coupling between the volume and the microphone, with the first and second couplings side-by-side.

### DETAILED DESCRIPTION OF THE INVENTION

The present invention is further elucidated by the following figures and examples, which are not intended to limit the scope of the invention. The person skilled in the art will understand that various embodiments may be combined.

### BRIEF DESCRIPTION OF THE DRAWINGS

FIG. 1 shows a schematic representation of an embodiment of a microphone assembly in accordance with an implementation of the invention,

FIG. 2 illustrates a schematic representation of another embodiment of a microphone assembly in accordance with an implementation of the invention,

FIG. 3 shows schematic diagrams of sound pressure levels and acoustic phases occurring at an embodiment of a microphone assembly in accordance with an implementation of the invention;

FIG. 4 illustrates a schematic representation of another embodiment of a microphone assembly in accordance with an implementation of the invention; and

FIG. 5 illustrates the embodiment of FIG. 4 in more detail.

### DETAILED DESCRIPTION OF THE DRAWINGS

In the following, embodiments are described which provide an improvement of stability in a headphone such as an in-ear-canal feedback acoustic noise reduction headphone, by means of a mechano-acoustical low pass filter for the microphone.

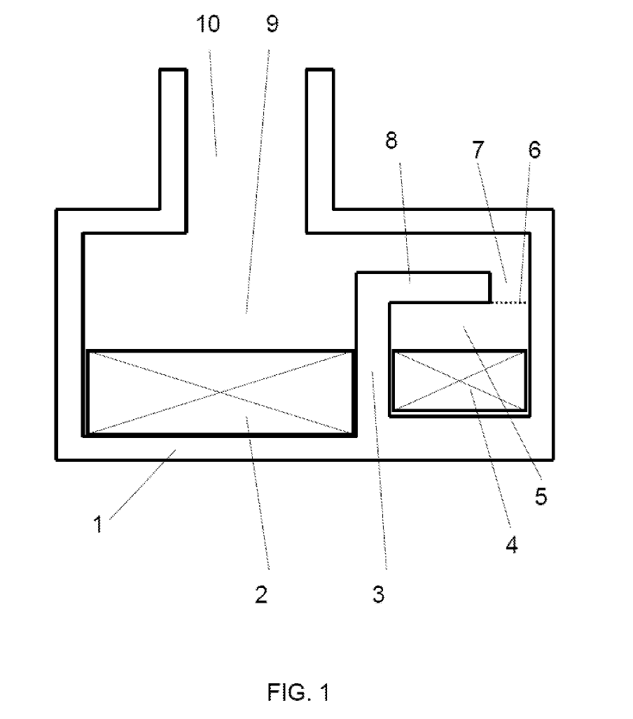

FIG. 1 shows a schematic illustration of an embodiment of a microphone or headset which is optionally implemented as an in-ear-canal headset or microphone, optionally with acoustic noise reduction or cancellation feedback such as an in-ear-canal feed-back headset.

The embodiment of FIG. 1 comprises a housing 1 which includes an ear speaker 2 which is connected to a front volume 9 of the ear speaker. The front volume 9 is further connected to a tube 10 which is adapted to be flanged into a human ear. For an optimal and tight fit a rubber plug or other eartip such as a foam plug may optionally be attached or snapped onto the tube 10. The housing 1 further comprises a microphone 4 with a front volume 5. A mechano acoustic high pass is roughly formed through separation of the speaker front volume 9 against the microphone front volume 5 of the microphone 4 by means of an intermediate wall 3 extending from the bottom of the housing 1 between theses volumes 9, 5. In the embodiment of FIG. 1, the wall 3 comprises an angularly, optionally rectangularly, bent wall part 8 extending above the front volume 5 in parallel to the upper internal housing wall nearly to the side wall of the housing 1

The wall 3 and wall part 8 provide a separation of the speaker front volume 9 against the microphone front volume 5 and therefore a mechano acoustic high pass. This separation is disrupted by a hole or tunnel 7 between the lateral end of the wall part 8 and the side wall of the housing 1. The hole or tunnel 7 forms an air gap and acoustically connects the volumes 5, 9. The hole or tunnel 7 provides a mechano-acoustic low pass filter between the volumes 5, 9.

The dimensions of the hole or tunnel 7 are depending on the dimension of the microphone front volume 5 and determine the upper corner frequency of the mechano acoustic low pass filter. Typical values for the microphone front volume 5 are 5 to 50 mm³; or to 30 mm³; or 20 mm³. The hole or tunnel 7 may have a round or circular cross-section or a polyangular such as a rectangular cross-section or shape. The diameter, or width and thickness, of the hole 7 may have a value of e.g. 0.2 to 2.0 mm; or 0.3 to 1.0 mm; or 0.5 mm. The length of the hole 7 may optionally be 1 to 5 mm; or 1.5 to 3 mm; or 2 mm. The upper corner or cutoff frequency of the mechano acoustic low pass filter may e.g. be set in the range of 1 to 20 kHz, or optionally at 2 to 10 kHz, or optionally at 4 to 8 kHz, or optionally at about or exactly 4 kHz.

The attenuation amount of the filtered frequency range filtered by the low pass filter formed by hole 7, can be adjusted by an appropriate damping material such as an acoustic fabric mesh 6 between the microphone front volume 5 and the hole or tunnel 7. The mesh 6 may alternatively also be arranged inside of the hole 7 or at the upper end of the hole 7, or at another appropriate position.

The same effect can be realized by filling the microphone front volume 5 with acoustic foam. The foam may be provided as an alternative, or in addition, to the mesh 6. Typical values for the acoustic resistance of the mesh or foam are 1-50 kOhm CGS.

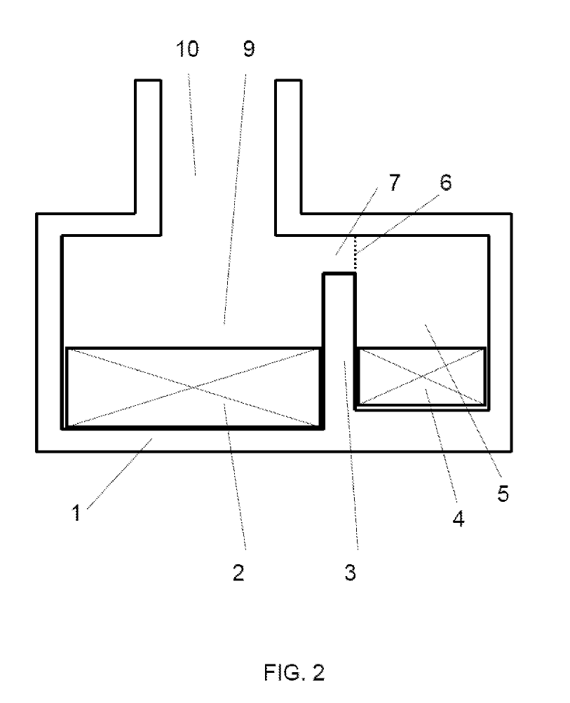

FIG. 2 shows another embodiment which corresponds to the embodiment of FIG. 1 apart from a changed configuration of the separation wall 3 and arrangement of the hole 7 as well as mesh 6. The details described above with regard to the FIG. 1 embodiment apply to the embodiment of FIG. 2 as well unless otherwise stated below, and are therefore not again repeated. In the embodiment of FIG. 2, the separation wall 3 does not have an angularly bent wall portion 8 but straightforwardly extends close to the internal upper wall side of the housing 1 with an air gap in-between, forming the hole or tunnel 7. The mesh 6 or foam is inserted at the hole side facing to the front volume 5 which may have a larger size as compared to the embodiment of FIG. 1.

Similar to the embodiment of FIG. 1, the hole or tunnel 7 provides a mechano-acoustic low pass filter between the volumes 5, 9. The dimensions of the hole or tunnel 7 may depend on the dimension of the microphone front volume 5 and determine the upper corner frequency of the mechano acoustic low pass filter. Typical values for the microphone front volume 5 are 5 to 50 mm³; or 10 to 30 mm³; or 20 mm³. The hole or tunnel 7 may have a round or circular cross-section or a polyangular such as a rectangular shape. The diameter, or width and thickness, of the hole 7 may have a value of e.g. 0.2 to 2.0 mm; or 0.3 to 1.0 mm; or 0.5 mm. The length of the hole 7 may optionally be 1 to 5 mm; or 1.5 to 3 mm; or 2 mm.

The embodiment of FIG. 2 provides the advantage of easy fabrication with effective low-pass filtering function.

In accordance with one or more of the embodiments, simpler filters for the acoustic noise reduction electronic are advantageously possible. Further, higher adjustable gain for noise reduction and less instability due to acoustic feedback is achievable.

One or more of the embodiments may be implemented as noise reduction headphones and headsets, or noise cancellation headphones and headsets.

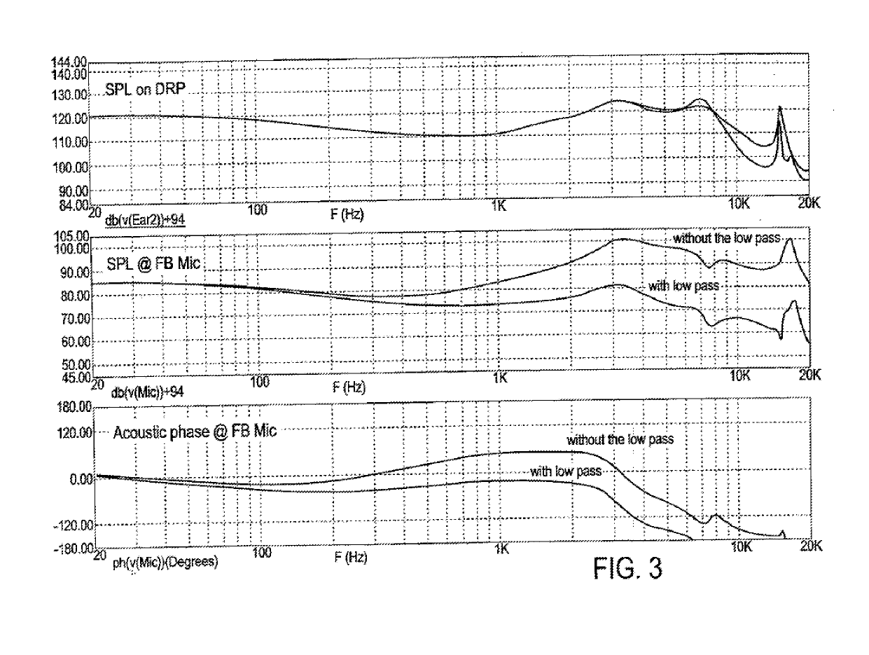

FIG. 3 illustrates three diagrams showing the sound pressure level SPL at the DRP (Drum Reference Point), upper curve; the sound pressure level SPL at the microphone 4 feedback, FB, path (curve at the center part of FIG. 3); and the acoustic phase at the microphone feedback path (lower curve). As derivable from FIG. 3, middle and lower curves, the mechano-acoustic low-pass filter formed by the hole or tunnel 7 advantageously reduces the acoustic phase shift (upper curve of the phase diagram as compared to the lower curve representing the phase without low-pass filter), and reduces the sound pressure level at the microphone (Mic) feedback, as shown by the lower curve of the middle diagram SPL at FB Mic.

The upper curve of the middle graph of FIG. 3 showing the sound pressure level at the microphone illustrates the sound pressure level without the low pass filter whereas the lower curve of the middle graph of FIG. 3 shows the significantly reduced sound pressure level at the microphone illustrates the sound pressure level when providing the low pass filter in accordance with one or more of the embodiments.

The upper curve of the lower graph of FIG. 3 showing the acoustic phase at the microphone illustrates the acoustic phase without the low pass filter whereas the lower curve of the lower graph of FIG. 3 shows the significantly reduced acoustic phase sensed at the microphone when providing the low pass filter in accordance with one or more of the embodiments.

Another feature of the designs of FIG. 1 and FIG. 2 is that the speaker 2 and microphone 4 are side-by-side. In particular, they are side-by-side in a plane perpendicular to the direction of sound projection to the user. The direction of sound projection to the user is the elongate axis direction of the tube 10. This side-by-side arrangement still places the microphone and speaker as close as possible together (i.e. the lateral space between them is kept to a minimum) but this arrangement avoids disturbing the high-frequency audio playback performance of the speaker. This is of particular interest for in-ear-canal headphones. In this arrangement, the microphone does not influence the acoustic path between the speaker and eardrum, and there is an undisturbed acoustic airflow.

The benefits of the side-by-side feature can be used obtained in designs which do not include the mechano-acoustical low pass filter.

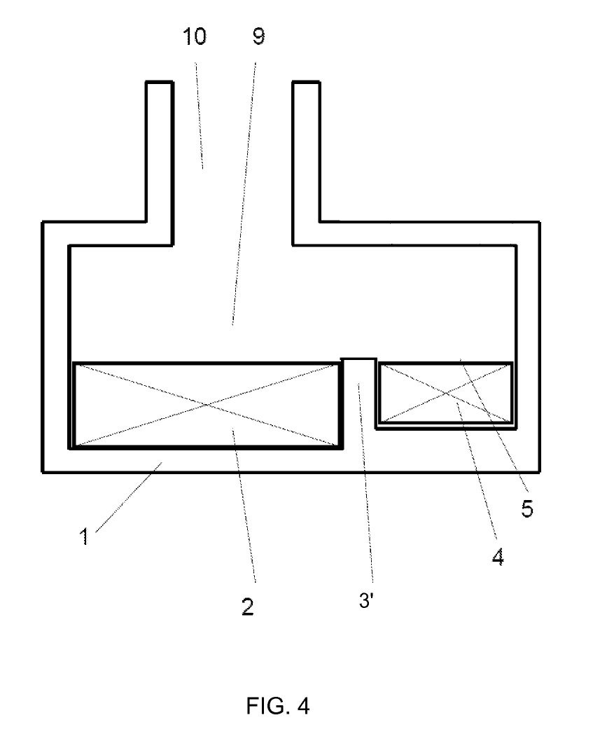

FIG. 4 shows a design in which no mechano-acoustical low pass filter is used. The same reference numbers as in FIG. 1 have been used for the same components. In this design, the intermediate wall 3′ simply functions as a positioning arrangement to provide seating of the speaker and microphone in the desired positions within the housing.

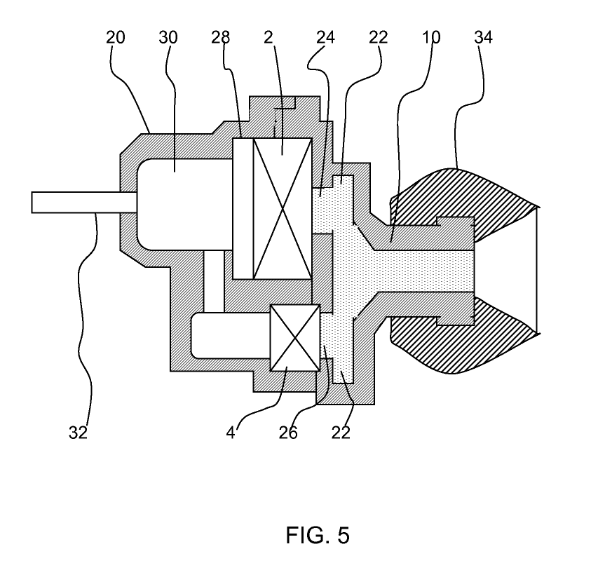

FIG. 5 shows the housing design in more detail for implementing the design of FIG. 4.

The outer casing of the microphone/speaker assembly is shown as 20, and this defines portions which provide the seating of the speaker 2 and microphone 4 in their desired locations.

The tube 10 extends in said direction of audio output to the user. In the example shown, the assembly is for positioning in the ear canal, and the tube 10 extends in the direction along the ear canal. The interior volume of the tube 10 opens to a volume 22 which is substantially planar in the plane perpendicular to the tube direction. This volume 22 has first coupling 24 to the speaker 2 and a second coupling 26 to the microphone 4, with the first and second couplings 24,26 side-by-side.

The speaker 2 has a back volume 28, and a rear part 30 of the ear piece housing is provided, which has no acoustic function. This can contain electronic circuitry, and also functions as the part of the housing held by the user to position the earphone. The electric cable 32 couples to this rear part. Electrical connections and circuitry between the speaker and the microphone are also provided within the housing. The rubber or silicon plug 34 provides a good fit between the ear piece and the human ear.

The volume 22 forms a pressure chamber with the ear canal and the eardrum at the end. The pressure chamber enables the same sound pressure level frequency response for low and mid range frequencies.

It will be apparent that the side-by-side arrangement can be used in combination with the mechano-acoustical low pass filter, and this combination is shown in FIG. 1 and FIG. 2. The mechano-acoustical low pass filter can be employed in other designs, for example with the microphone in front of the speaker.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

Any reference signs in the claims should not be construed as limiting the scope.

1-10. (canceled)

11. A microphone/speaker assembly comprising:
a microphone and
a speaker,
wherein a mechanical acoustical low pass filter is provided between the microphone and the speaker, wherein the low pass filter comprises a hole or tunnel which connects a front volume of the microphone with a front volume of the speaker, wherein the assembly further comprises a separation wall between a front volume of the microphone and a front volume of the speaker and the hole or tunnel is arranged between the separation wall and an internal wall of a housing of the microphone assembly.

12. The microphone/speaker assembly as recited in claim 11, wherein the hole or tunnel has a round or circular cross-section or a polyangular or rectangular shape.

13. The microphone/speaker assembly as recited in claim 11 wherein the hole or tunnel has an opening size from about 0.2 mm to about 2 mm, and/or the hole or tunnel has a length from about 1 mm to about 5 mm.

14. The microphone/speaker assembly as recited in claim 13 wherein the hole or tunnel has an opening size from about 0.3 mm to about 1 mm, and/or the hole or tunnel has a length from about 1.5 mm to about 3 mm.

15. The microphone/speaker assembly as recited in claim 14 wherein the hole or tunnel has an opening size of about 0.5 mm and/or the hole or tunnel has a length of about 2 mm.

16. The microphone/speaker assembly as recited in claim 1, wherein the separation wall comprises an angular part extending parallel to an internal wall of the housing of the microphone assembly.

17. The microphone/speaker assembly as recited in claim 11, comprising an attenuation material for adjusting the attenuation of the low pass filter comprising an acoustic fabric or mesh arranged at or in a hole or tunnel of the low pass filter or an acoustic foam arranged at or in a microphone front volume.

18. The microphone/speaker assembly as recited in claim 7, wherein the mesh is attached to the separation wall and the housing.

19. The microphone/speaker assembly as recited in claim 1, wherein the upper corner frequency of the low pass filter is set in the range of about 1 kHz to about 20 kHz.

20. The microphone/speaker assembly as recited in claim 19, wherein the upper corner frequency of the low pass filter is set in the range of about 2 kHz to about 10 kHz.

21. The microphone/speaker assembly as recited in claim 20, wherein the upper corner frequency of the low pass filter is set in the range of about 4 kHz to about 8 kHz.

22. The microphone/speaker assembly as recited in claim 21, wherein the upper corner frequency of the low pass filter is set at about 4 kHz.

23. The microphone/speaker assembly as recited in claim 11, wherein the microphone and speaker are arranged side-by-side in a plane perpendicular to the direction of sound projection to the user.

24. The microphone/speaker assembly as recited in claim 11, comprising a tube adapted for insertion into a human ear.

25. The microphone/speaker assembly as recited in claim 11, wherein the microphone/speaker assembly is at least one of a headphone, an in-ear-canal headphone, and a headset, with feedback noise reduction or cancellation.
